(19) United States
(12) Patent Application Publication
(10) Pub. No.: US 2008/0018818 A1
(43) Pub. Date: Jan. 24, 2008

(54) LIQUID CRYSTAL DISPLAY PANEL AND ACTIVE DEVICE ARRAY SUBSTRATE THEREOF

(75) Inventors: Tsung-Yuan Chang, Taoyuan (TW); Chih-Chieh Chang, Taoyuan (TW); Pin-Chun Wu, Taoyuan (TW); Chih-Hsiung Weng, Taoyuan (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: QUANTA DISPLAY INC., Taoyuan (TW)

(21) Appl. No.: 11/554,589

(22) Filed: Oct. 31, 2006

(30) Foreign Application Priority Data
Jul. 19, 2006 (TW) 95126331

(51) Int. Cl. G02F 1/136

(52) U.S. Cl. 349/43

(57) ABSTRACT

An active device array substrate including a substrate, a plurality of scan lines, a plurality of data lines, a plurality of active devices, a patterned passivation layer, a plurality of pixel electrodes and a sealant layer is provided. The scan lines, the data lines and the active devices are disposed over the substrate. Each active device is electrically connected to one of the scan lines and one of the data lines correspondingly. The active devices are covered by the patterned passivation layer having a plurality of ditches. Additionally, the pixel electrodes are disposed on the patterned passivation layer and electrically connected to the corresponding active device. The sealant layer is located surrounding the display area, and a buffer area is located between the sealant layer and the display area. Moreover, the ditches are communicated to the buffer area.

### CROSS-REFERENCE TO RELATED APPLICATION

This application claims the priority benefit of Taiwan application serial no. 95126331, filed on Jul. 19, 2006. All disclosure of the Taiwan application is incorporated herein by reference.

### BACKGROUND OF THE INVENTION

1. Field of the Invention

The present invention relates to a display device, and more particularly, to a liquid crystal display panel and an active device array substrate thereof.

2. Description of Related Art

Liquid crystal display panels have the advantages of high definition, small volume, light weight, low driving voltage, low power consumption and wide application range. Therefore, the liquid crystal display panel has been widely applied in consumer electronic products such as medium and mini size potable televisions, mobile phones, video cameras, notebooks and desktop displays, which has gradually replaced the Cathode Ray Tube (CRT) to become the mainstream of the display.

The liquid crystal display panel mainly includes an active device array substrate, a color filter substrate and a liquid crystal layer sandwiched there-between. Generally, the method of filling the liquid crystal layer mainly includes vacuum suction method and one drop fill (ODF) method. The vacuum suction method includes the following steps. First, a display panel without being filled with a liquid crystal layer is placed within a chamber, wherein the display panel has a liquid crystal filling opening. Next, the air in the chamber is pumped out to create a substantially vacuum state, and the liquid crystal filling opening of the display panel is immersed into a liquid crystal dish in the chamber. Then, the pressure within the chamber is allowed to return to the normal (room) pressure, such that the liquid crystal molecules in the liquid crystal dish are filled into the gap between the two substrates via the liquid crystal filling opening under vacuum.

However, as the size of the liquid crystal display panel becomes increasingly large, filling crystal liquids through the vacuum suction method is quite time consuming. Therefore, during the assembly process of a large-size liquid crystal display panel, the filling process is mostly achieved through ODF method. Particularly, before performing the ODF, a sealant is formed on the boundary of the display area of the active device array substrate, so as to enclose a space for accommodating liquid crystals. Then, the dropping amount of the liquid crystals is estimated according to the volume of the liquid crystal accommodation space and the cell gap between the two substrates, and then, the liquid crystals are dropped into the liquid crystal accommodation space. Finally, the active device array substrate and the color filter substrate are aligned and assembled, and then, the liquid crystals are sealed between the two substrates with the sealant.

Whether or not the cell gap between the two substrates is appropriately controlled directly influences the response rate, contrast value and visible angle of the liquid crystal display panel. Generally, the cell gap is precisely controlled according to the optical property of the liquid crystal material, and the common method is to dispose a spacer between the two substrates to maintain a fixed cell gap. It should be noted that, it is not easy to accurately control the dropping amount of the liquid crystals. During the process of dropping the liquid crystals, if the liquid crystal dropping amount is excessively small that the liquid crystals cannot effectively fill up the liquid crystal accommodation space, air bubbles may appear in the liquid crystal display panel, thereby adversely influencing the display quality.

If the liquid crystal dropping amount is excessive large that the spacer possibly cannot support the upper and lower substrates effectively, the cell gap between the two substrates is adversely influenced by the excessive liquid crystals. On the other hand, the redundant liquid crystal molecules in the liquid crystal display panel may vertically flow downwards under gravity and may get concentrated at the bottom of the liquid crystal display panel, thereby causing the mura phenomenon on the display frame of the liquid crystal display panel. Thus, further improvement in filling the liquid crystals is highly desirable.

### SUMMARY OF THE INVENTION

An objective of the present invention is to provide an active device array substrate capable of resolving the problems due to excessive amount of liquid crystals described above.

Another objective of the present invention is to provide a liquid crystal display panel with high display quality. The possibility of excess liquid crystal molecules vertically flowing downwards under gravity that may get concentrated at the bottom of the liquid crystal display panel may be reduced and thereby resolve the mura phenomenon on the display frame of the liquid crystal display panel.

In order to achieve the above or other objectives, the present invention provides an active device array substrate, which has a display area. The active device array substrate comprises a substrate, a plurality of scan lines, a plurality of data lines, a plurality of active devices, a patterned passivation layer, a plurality of pixel electrodes and a sealant layer. The scan lines, the data lines and the active devices are all disposed over the substrate. Moreover, the active devices are arranged in array in the display area, where each active device is electrically connected to one of the scan lines and one of the data lines correspondingly. The active devices are covered by the patterned passivation layer having a plurality of ditches. Additionally, the pixel electrodes are arranged in array on the patterned passivation layer in the display area, and electrically connected to the corresponding active device respectively, where the positions of the ditches correspond to the gaps between the pixel electrodes. The sealant layer is located surrounding the display area, a buffer area is located between the sealant layer and the display area, and the ditches are communicated to the buffer area.

In an embodiment of the present invention, the ditches extend in the direction of the scan lines.

In an embodiment of the present invention, the ditches extend in the direction of the data lines.

In an embodiment of the present invention, at least one of the ditches has a bottom part with a width the same as that of openings of the ditches.

In an embodiment of the present invention, at least one of the ditches has a bottom part with a width smaller than that of openings of the ditches.

In an embodiment of the present invention, the active device array substrate further comprises an alignment film layer covered on the pixel electrodes and at least part of the patterned passivation layer, and being congruent with the ditches.

In an embodiment of the present invention, the active device array substrate further comprises a plurality of barriers surrounding the boundary of the display area, so as to form the buffer area.

In an embodiment of the present invention, at least one of the height of the barriers has a height smaller than that of the sealant layer.

The present invention provides a liquid crystal display panel, which comprises an active device array substrate, an opposite substrate and a liquid crystal layer sandwiched there-between. The active device array substrate with a display area comprises a substrate, a plurality of scan lines, a plurality of data lines, a plurality of active devices, a patterned passivation layer, a plurality of pixel electrodes and a sealant layer. The substrate has a display area, and the scan lines, the data lines and the active devices are all disposed over the substrate. Moreover, the active devices are arranged in array in the display area, and each active device is electrically connected to one of the scan lines and one of the data lines correspondingly. The active devices are covered by the patterned passivation layer having a plurality of ditches. Additionally, the pixel electrodes are arranged in array on the patterned passivation layer in the display area, and electrically connected to the corresponding active device respectively, wherein the positions of the ditches correspond to the gaps between the pixel electrodes. The sealant layer is located surrounding the display area, a buffer area is located between the sealant layer and the display area, and the ditches are communicated with the buffer area.

In an embodiment of the present invention, a first alignment film layer is further included, which covers the pixel electrodes and at least part of the patterned passivation layer, and is congruent with the ditches.

In an embodiment of the present invention, the opposite substrate comprises a substrate, a black matrix, a plurality of color filter films, a common electrode and a second alignment film layer. The black matrix is disposed over the substrate and has a plurality of lattice points. Additionally, the color filter films are disposed over the substrate and respectively located in the lattice points. The common electrode covers the black matrix and the color filter films. The second alignment film layer is disposed on the common electrode.

In an embodiment of the present invention, the ditches extend in the direction of the scan lines.

In an embodiment of the present invention, the ditches extend in the direction of the data lines.

In an embodiment of the present invention, at least one of the ditches has a bottom part with a width the same as that of openings of the ditches.

In an embodiment of the present invention, at least one of the ditches has a bottom part with a width smaller than that of openings of the ditches.

In an embodiment of the present invention, the liquid crystal display panel further comprises a plurality of barriers disposed between the substrate and the opposite substrate, corresponding to the boundary of the display area, so as to form a buffer area between the display area and the sealant layer, and the ditches are communicated to the buffer area.

In the present invention, the patterned passivation layer on the active device array substrate comprises ditches that are capable of uniformly diffusing the liquid crystal molecules, and thus, after the active device array substrate and the opposite substrate have been assembled, redundant liquid crystal molecules may be effectively diffused to the buffer area via the ditches, such that a preferred cell gap between the upper and lower substrates can be effectively maintained, thereby enhancing the display quality of the liquid crystal display panel.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this disclosure. The drawings illustrate embodiments of the invention and, together with the description, serve to explain the principles of the invention.

FIG. 1 is a schematic cross-sectional view of a liquid crystal display panel according to an embodiment of the present invention.

FIG. 2 is a schematic circuit diagram of an active device array substrate according to an embodiment of the present invention.

FIG. 3 is a schematic view of a ditch according to an embodiment of the present invention.

FIG. 4 is a schematic cross-sectional view of a ditch according to another embodiment of the present invention.

FIGS. 5A to 5E are schematic views of patterns of various ditches according to the present invention.

### DESCRIPTION OF EMBODIMENTS

### First Embodiment

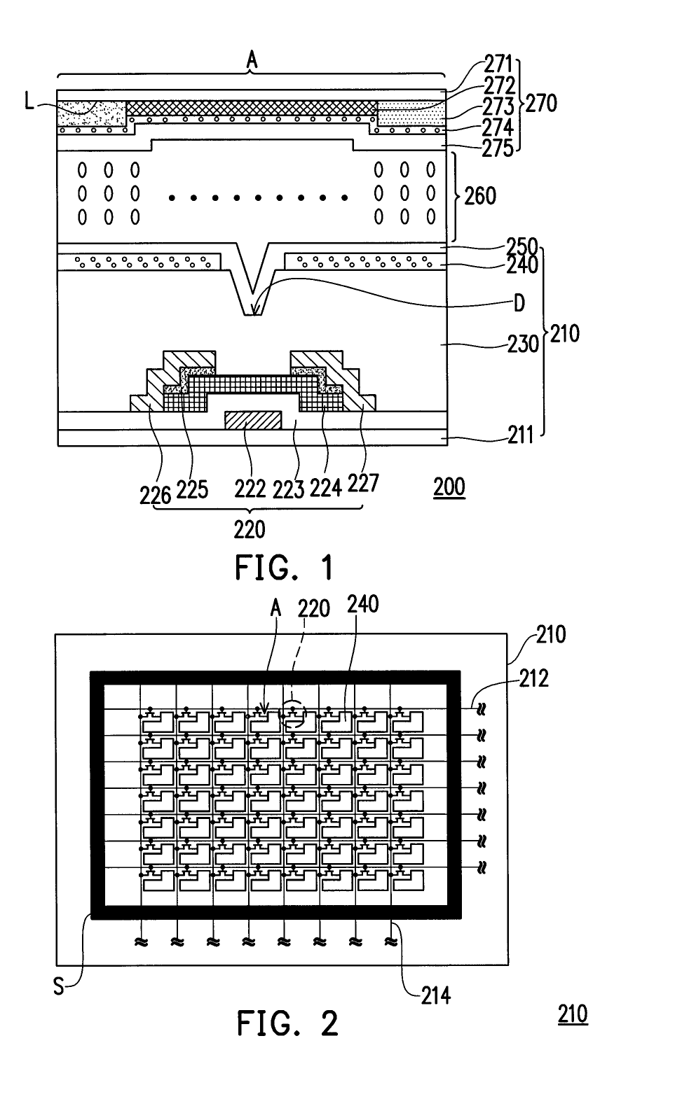

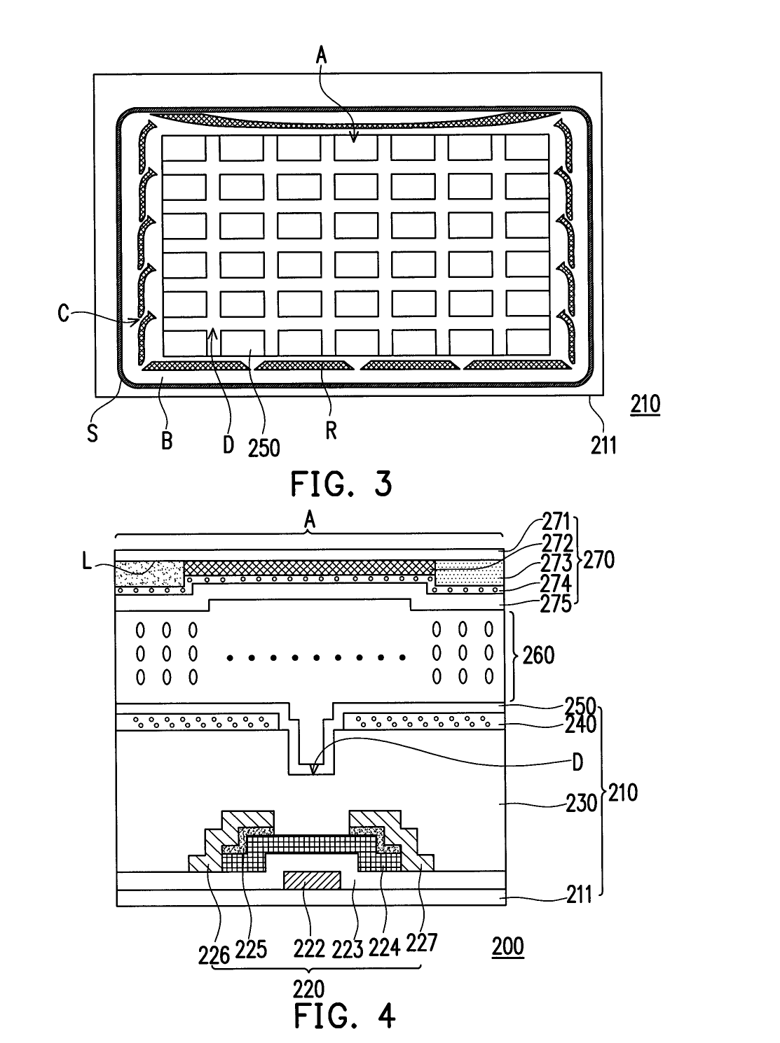

FIG. 1 is a schematic cross-sectional view of a liquid crystal display panel according to an embodiment of the present invention, and FIG. 2 is a schematic circuit diagram of an active device array substrate according to an embodiment of the present invention. Referring to both FIGS. 1 and 2, the liquid crystal display panel 200 of the present invention includes an active device array substrate 210, a liquid crystal layer 260 and an opposite substrate 270, wherein the liquid crystal layer 260 is located between the active device array substrate 210 and the opposite substrate 270. Particularly, the active device array substrate 210 of the present invention has a display area A and includes a substrate 211, a plurality of scan lines 212, a plurality of data lines 214, a plurality of active devices 220, a patterned passivation layer 230, a plurality of pixel electrodes 240 and a sealant layer S. The scan lines 212 and the data lines 214 are used to divide positions for the active devices 220 in the display area A.

As shown in FIG. 2, the active devices 220 of the present invention are arranged in an array within the display area A, and each active device 220 is electrically connected to the scan line 212 and the data line 214 correspondingly. Additionally, the active devices 220 are electrically connected to the corresponding pixel electrodes 240. Particularly, the active devices 220 is turned on through a switch signal transmitted via the scan lines 212, and after the active devices 220 has been turned on, a display signal is transmitted to the pixel electrodes 240 via the data lines 214. While the active device 220 shown in FIG. 1 is a bottom gate structure, it is not particularly limited herein as such. Rather, the active devices 220 may also be a top gate structure.

For example, the active device 220 includes a gate 222, a gate insulation layer 223, a channel layer 224, an ohmic contact layer 225, a source 226 and a drain 227. The gate 222 is disposed on the substrate 211, and is covered by the gate insulation layer 223. Moreover, the channel layer 224 is disposed on the gate insulation layer 223 above the gate 222. Generally, the channel layer 224 is made of a semiconductor material, and the source 226 and the drain 227 are made of metals. In practice, in order to reduce the contact impedance between the metal material and the semiconductor material, an ohmic contact layer 225 is respectively formed between the source 226 and the channel layer 224 and between the drain 227 and the channel layer 224.

Particularly, the scan line 212 is electrically connected to the gate 222 of the active device 220, and the data line 214 is electrically connected to the source 226 of the active device 220. In addition, the patterned passivation layer 230 covers the active device 220, the scan line 212 and the data line 214, and the material of the patterned passivation layer 230 is generally selected from a group consisting of an organic material, silicon nitride, silicon oxide or silicon oxynitride, or any combination thereof. In practice, the drain 227 of the active device 220 is electrically connected to the pixel electrode 240 via a contact hole (not shown) in the patterned passivation layer 230. The pixel electrodes 240 are arranged in array on the patterned passivation layer 230 in the display area A. The active device array substrate 210 further includes a first alignment film layer 250 for aligning the liquid crystals and covering the pixel electrodes 240 and a part of the patterned passivation layer 230.

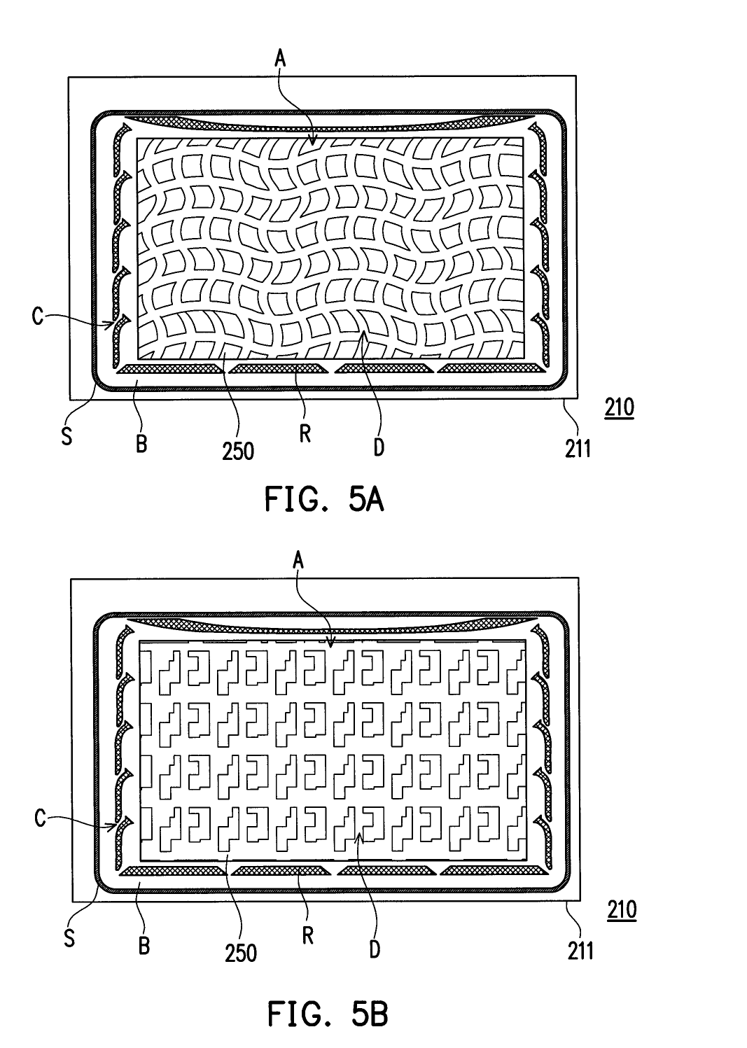

FIG. 3 is a schematic view of a ditch according to an embodiment of the present invention. Referring to both FIGS. 1 and 3, it should be noted that the patterned passivation layer 230 of the present invention has a plurality of ditches D, and that the first alignment film layer 250 is filled into the ditches D and thereby being congruent with the ditches D. Moreover, the sealant layer S is located surrounding the display area A, a buffer area B is located between the sealant layer S and the display area A, and the ditches D are communicated to the buffer area B. The ditches D may be integrally formed on the patterned passivation layer 230 through one photolithography process, and thus the fabrication of the ditches D of the present invention does not require any additional process.

As shown in FIG. 3, the active device array substrate 210 further includes a plurality of barriers R, which are located surrounding the boundary of the display area A, so as to form a buffer area B between the display area A and the sealant layer S. It should be noted that gaps C with a suitable size exist between the barriers R, and therefore the ditches D communicate with the buffer area B via the gaps C. In an embodiment of the present invention, the height of the barrier R is smaller than the cell gap between the active device array substrate 210 and the opposite substrate 270, such that the ditches D communicate with the buffer area B via the cell gap (not shown) between the barrier R and the opposite substrate 270.

In practice, the barrier R of the present invention may be selectively formed on the active device array substrate 210 or on the opposite substrate 270. Alternatively, the barrier R may also be formed to partially overlap the active device array substrate 210 and the opposite substrate 270, which is not particularly limited herein as such.

When performing the ODF process, liquid crystal drops are first dropped in the display area A (on the first alignment film layer 250) of the active device array substrate 210. Then, the active device array substrate 210 and the opposite substrate 270 are aligned and assembled together in a substantially vacuum environment. At this time, the liquid crystals are diffused more uniformly with the ditches D. In order to further enhance the diffusion efficiency of the liquid crystals, a thermal rotation process is selectively performed to the liquid crystal display panel 200, which reduces the viscosity of the liquid crystals by raising the temperature, and further enhances the diffusion efficiency of the liquid crystals by spinning the liquid crystal display panel 200. Therefore, the liquid crystals are uniformly distributed on the liquid crystal display panel 200.

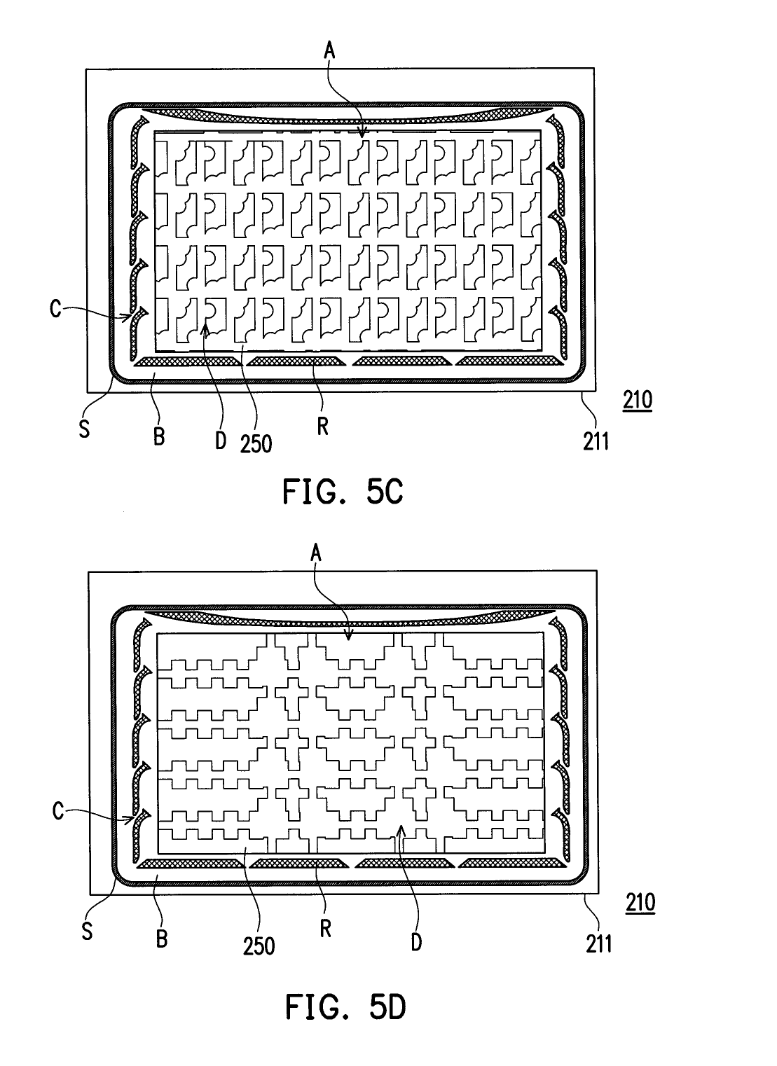

Referring to FIG. 1 again, the position of the ditch D corresponds to the gap between the pixel electrodes 240, and the width of the bottom part of the ditch D is smaller than that of its opening, and of course, the width of the bottom part of the ditch D may be the same as that of its opening (as shown in FIG. 4), which may be adjusted appropriately depending upon actual requirements. In addition, in FIG. 3, one part of the ditches D extends in the direction of the scan lines 212, and the other part of the ditch D extends in the direction of the data lines 214. Of course, the ditches D may selectively extend in the direction of the scan lines 212, or only extend in the direction of the data lines 214, which is not specifically limited herein as such.

Particularly, during the ODF process, if the dropping amount of the liquid crystals is excessively large, the redundant liquid crystals flow towards the buffer area B after the active device array substrate 210 and the opposite substrate 270 of the present invention have been assembled together, thereby maintaining an adequate amount of liquid crystals between the two substrates. Thus, the active device array substrate 210 and the opposite substrate 270 of the present invention can effectively reduce the possibility of the adverse influence caused due to the excessive filling of liquid crystals, thereby maintain a desired cell gap between the two substrates. On the other hand, the liquid crystal display panel 200 of the present invention may also effectively avoid the mura phenomenon caused due to the vertical flow of redundant liquid crystals.

It should be noted that, as the gaps C are very small, the liquid crystals do not easily pass there through under a normal circumstance, but only under the circumstance that excessive liquid crystals have been dropped. The redundant liquid crystals flow towards the buffer area B under the pressure generated when the active device array substrate 210 and the opposite substrate 270 are assembled together. However, once the liquid crystals flow to the buffer area B, it is not easy for them to flow back.

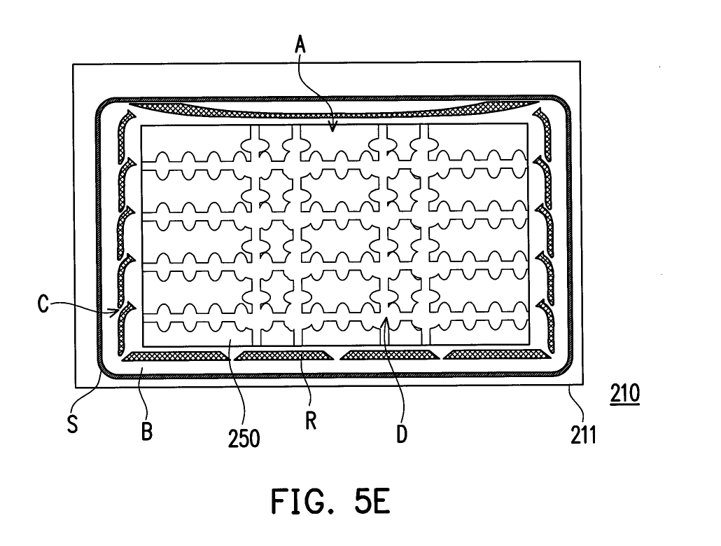

FIGS. 5A to 5E are schematic views of patterns of various ditches according to the present invention. Referring to FIGS. 5A to 5E, in order to further enhance the diffusion efficiency of the liquid crystals, the pattern of the ditches D may be changed appropriately, which is not specifically limited herein as such. The various patterns of ditches D shown in FIGS. 5A to 5E may be achieved by adjusting the mask patterns employed in patterned process.

Referring to FIG. 1 again, the opposite substrate 270 of the present invention includes a substrate 271, a black matrix 272, a plurality of color filter films 273, a common electrode 274, and a second alignment film layer 275. The black matrix 272 is disposed over the substrate 271, and it has a plurality of lattice points L. The color filter films 273 are disposed over the substrate 271 and respectively located in the lattice points L. Particularly, the color filter films 273 include red resin, green resin and blue resin, and the liquid crystal display panel 200 of the present invention may achieve the full color display with the color filter films 273. Moreover, the common electrode 274 covers the black matrix 272 and the color filter films 273, and the second alignment film layer 275 for aligning the liquid crystals is disposed on the common electrode 274. Generally, the common electrode 274 is coupled to a reference voltage source, and the common electrode 274 may form an electric field with the pixel electrode 240, so as to drive the liquid crystals.

The ditches D and/or active devices 220 are disposed below the black matrix 272, as shown in FIG. 1. Therefore, the black matrix 272 effectively shields the light leakage phenomenon caused by the electric field interference of the active devices 220, thereby further maintaining the display quality of the liquid crystal display panel 200.

According to the present invention, the patterned passivation layer on the active device array substrate has ditches, which are capable of uniformly diffusing liquid crystal molecules, such that redundant liquid crystal molecules may be diffused towards the buffer area via the ditches. Thus, a desired cell gap is maintained between the upper and lower substrates, thereby enhancing the display quality of the liquid crystal display panel.

It will be apparent to those skilled in the art that various modifications and variations can be made to the structure/process of the present invention without departing from the scope or spirit of the invention. In view of the foregoing, it is intended that the present invention covers modifications and variations thereof, provided they fall within the scope of the appended claims.

What is claimed is:

1. An active device array substrate having a display area and a buffer area, comprising:
a substrate;
a plurality of scan lines disposed over the substrate;
a plurality of data lines disposed over the substrate;
a plurality of active devices disposed over the substrate and arranged in an array in the display area, wherein each active device is electrically connected to one of the scan lines and one of the data lines correspondingly;
a patterned passivation layer covering the active devices, wherein the patterned passivation layer has a plurality of ditches;
a plurality of pixel electrodes arranged in array on the patterned passivation layer in the display area and electrically connected to corresponding active devices respectively, wherein positions of the ditches correspond to gaps between the pixel electrodes; and
a sealant layer located surrounding the display area, wherein the buffer area is located between the sealant layer and the display area, and the ditches communicate with the buffer area.

2. The active device array substrate of claim 1, wherein the ditches extend in a direction of the scan lines.

3. The active device array substrate of claim 1, wherein the ditches extend in a direction of the data lines.

4. The active device array substrate of claim 1, wherein at least one of the ditches has a bottom part with a width the same as that of openings of the ditches.

5. The active device array substrate of claim 1, wherein at least one of the ditches has a bottom part with a width smaller than that of openings of the ditches.

6. The active device array substrate of claim 1, further comprising an alignment film layer covering the pixel electrodes and at least part of the patterned passivation layer, and being congruent with the ditches.

7. The active device array substrate of claim 1, further comprising a plurality of barriers surrounding a boundary of the display area so as to form the buffer area.

8. The active device array substrate of claim 7, wherein at least one of the barriers has a height smaller than that of the sealant layer.

9. A liquid crystal display panel, comprising:
an active device array substrate having a display area and a buffer area, comprising:
a substrate;
a plurality of scan lines disposed over the substrate;
a plurality of data lines disposed over the substrate;
a plurality of active devices disposed over the substrate and arranged in array in the display area, wherein each active device is electrically connected to one of the scan lines and one of the data lines correspondingly;
a patterned passivation layer covering the active devices, wherein the patterned passivation layer has a plurality of ditches;
a plurality of pixel electrodes arranged in array on the patterned passivation layer in the display area and electrically connected to corresponding active devices respectively, wherein positions of the ditches correspond to gaps between the pixel electrodes; and
a sealant layer located surrounding the display area, wherein the buffer area is located between the sealant layer and the display area, and the ditches communicate with the buffer area;
an opposite substrate disposed above the active device array substrate; and
a liquid crystal layer disposed between the active device array substrate and the opposite substrate.

10. The liquid crystal display panel of claim 9, further comprising a first alignment film layer covering the pixel electrodes and at least part of the patterned passivation layer, and being congruent with the ditches.

11. The liquid crystal display panel of claim 9, wherein the opposite substrate comprises:
a substrate;
a black matrix, disposed over the substrate, having a plurality of lattice points;
a plurality of color filter films disposed over the substrate and respectively located in the lattice points;
a common electrode covering the black matrix and the color filter films; and
a second alignment film layer disposed on the common electrode.

12. The liquid crystal display panel of claim 9, wherein the ditches extend in a direction of the scan lines.

13. The liquid crystal display panel of claim 9, wherein the ditches extend in a direction of the data lines.

14. The liquid crystal display panel of claim 9, wherein at least one of the ditches has a bottom part with a width the same as that of openings of the ditches.

15. The liquid crystal display panel of claim 9, wherein at least one of the ditches has a bottom part with a width smaller than that of openings of the ditches.

16. The liquid crystal display panel of claim 9, further comprising a plurality of barriers, disposed between the substrate and the opposite substrate, corresponding to a boundary of the display area, so as to form the buffer area.

17. The liquid crystal display panel of claim 16, wherein at least one of the barriers has a height smaller than that of the sealant layer.
